(19) United States
(12) Patent Application Publication
(10) Pub. No.: US 2024/0152712 A1
(43) Pub. Date: May 9, 2024

(54) TOGGLING FUNCTIONS FOR A RING SCANNER USING MAPPED KEYWORDS

(71) Applicant: INFINITE PERIPHERALS, INC., Irvine, CA (US)

(72) Inventor: John BRODERICK, Corona, CA (US)

(73) Assignee: INFINITE PERIPHERALS, INC., Irvine, CA (US)

(21) Appl. No.: 18/386,733

(22) Filed: Nov. 3, 2023

Related U.S. Application Data
(60) Provisional application No. 63/422,198, filed on Nov. 3, 2022.

(51) Int. Cl. G06K 7/10; G06K 7/14

(52) U.S. Cl. CPC G06K 7/1095; G06K 7/10396; G06K 7/1417

(57) ABSTRACT

A ring scanner is disclosed. The ring scanner is configured to receive an input selection of a keyword displayed on a display of the ring scanner. The keyword is linked to a routing function and the routing function is configured to route a scanned image or barcode obtained by the ring scanner to a destination computing device. Based on the input selection, the ring scanner can route the scanned image or barcode to the destination computing device. The ring scanner can receive from the destination computing device, a graphic to be displayed on the display of the ring scanner in response to the destination computing device processing the scanned image or barcode. The graphic can displays information or an action to be taken in response to the scanned image or barcode. The graphic may be displayed.

### CROSS-REFERENCE TO RELATED APPLICATIONS

This application claims the benefit from U.S. Provisional Application 63/422,198, filed on Nov. 3, 2022, the contents of which is incorporated by reference herein in its entirety.

### BACKGROUND

### Field

This field is generally related to scanning devices.

### Related Art

Optical labels, such as barcodes, represent data in a visual, machine-readable format. One type of barcode, known as linear or one-dimensional (1D) barcodes, can represent data by varying the widths and spacing of parallel lines. Another type of barcode, known as matrix codes, two-dimensional (2D) barcodes, or QR codes, use rectangles, dots, hexagons and other patterns to represent data.

Barcodes have many applications. In stores, universal product code (UPC) barcodes are pre-printed on most items and are used for inventory and to check out. Barcodes are used in healthcare and hospital settings, for things like patient identification (to access patient data, including medical history, drug allergies, etc.). They can also be used to keep track of objects and people; they are used to keep track of rental cars, airline luggage, nuclear waste, registered mail, express mail and parcels. Barcoded tickets allow the holder to enter sports arenas, cinemas, theatres, fairgrounds, and transportation, and are used to record the arrival and departure of vehicles from rental facilities, etc.

A barcode reader (or barcode scanner) is an optical scanner that can read printed barcodes, decode the data contained in the barcode and send the data to a computer. One type of handheld scanner is gripped in a user's palm. With these handheld barcode scanners, the user encloses the handle with all five fingers and uses the trigger button to activate the scanner, like the operation of a handgun. One downside of handheld barcode scanners is that the user of the scanner has to put down the scanner to use his hand. If the user is transporting packages or taking inventory having to repeatedly put down and pick up the scanner it can result in lost productivity.

To reduce this inefficiency, ring scanners operate by looping around at least one finger, enabling an operator to continue using both hands while carrying the scanner. In this way, workers can continue to use both hands when climbing ladders or stairs, handling large items, or operating machinery.

Ring scanners, however, often lack the ability to present data to the operator. In some cases, if output is needed for the operator, it may be presented in a separate display that the operator might not even be viewing. In one example operation, a postage worker may be scanning packages and some subset of those packages may be flagged for the postage worker to take aside for further inspection. In the postage worker example, there may be a separate display that displays data when the worker scans a package that needs special treatment.

Even when ring scanners have displays integrated to present data to the operator, these displays require the operator to manually go through screens, choices, or menus, or to touch through various on screen choices to indicate what actions are to be taken for a scanned image or barcode. For example, taking the postage worker example once again, when scanning a package, the postage worker will typically have to go through a series of icons or menu options to have the ring scanner know what to do with a scan of a barcode or image of the package. This may be cumbersome because an operator will have to manually go through options and select which actions are to be taken for each package.

To address these issues, improved rings scanners are needed.

### BRIEF SUMMARY

Systems, methods, and non-transitory computer readable media are disclosed to allow an operator/user of a ring scanner to toggle between functions of the ring scanner. This may be done by allowing the operator to select from a plurality of keywords displayed on a display of the ring scanner. Each of the plurality of keywords is mapped to a specific function to be performed by the ring scanner for a scanned image or barcode. The use of these mapped keywords solves the problem of having to scroll through a series of icons and/or menu options to have the ring scanner know what to do with a scanned image or barcode. Thus, by selecting a keyword from the plurality of keywords, and scanning an image or barcode, the ring scanner can automatically know what to do with a scanned image or barcode. For example, the ring scanner can know where to route the scanned image or barcode so that it may be processed properly.

In aspects, to implement the claimed subject matter, the operator of the ring scanner can use buttons of the ring scanner to toggle between the plurality of keywords displayed on the screen of the ring scanner. Each of the plurality of keywords may be preprogrammed to cause the ring scanner to perform a particular function. For example, this may be a routing function for a scanned image or barcode. The ring scanner can receive an input selection of a keyword from amongst a plurality of keywords chosen by the operator. The input selection may be obtained by having the operator toggle between the plurality of keywords using buttons of the ring scanner to move forward or backward between the plurality of keywords.

In aspects, each of the plurality of keywords may be linked to a function of the ring scanner. For example, each may be linked to a routing function, and the routing function may be configured to route the scanned image or barcode obtained by the ring scanner to a destination computing device. The destination computing device can have rules and/or logic stored thereon to process the scanned image or barcode. The rules and/or logic may be implemented as software, and allow the destination computing device to know what to do with the scanned image or barcode. Thus, the scanned image or barcode may be routed to a destination computing device that is preprogrammed to recognize the particular scanned image or barcode and to know what to do with the scanned image or barcode.

In aspects, the ring scanner can receive the scanned image or barcode via an optical scanner of the ring scanner. As indicated, based on the input selection, the scanned image or barcode may be routed to the destination computing device. In aspects, the destination computing device can process the scanned image or barcode and generate a graphic representing an output or response as a result of the processing. In aspects, the ring scanner can receive the graphic from the destination computing device. In aspects, the graphic may be displayed on the display of the ring scanner. In aspects, the graphic can display information or an action to be taken in response to the scanned image or barcode. For example, the information can represent information regarding a destination or source of a package if the scanned image or barcode is for a package being sent or received by, for example, a postal service. Another example of information may be an identity of an individual if the barcode that is scanned is the barcode on a driver's license.

If an action is to be performed, the graphic can display further interactive graphical icons/buttons that may be displayed on the display of the ring scanner. These interactive graphical icons can solicit information from the operator. For example, if a package is scanned to report the condition of the package, the interactive graphical icon can ask the operator whether the package is damaged or not. The operator can select between two buttons, for example “DAMAGED” or “NOT DAMAGED” to report the condition of the package. The condition can then be transmitted to be recorded in a database either at the destination computing device or elsewhere.

### BRIEF DESCRIPTION OF THE DRAWINGS

The accompanying drawings, which are incorporated herein and form part of the specification, illustrate the present disclosure and, together with the description, further serve to explain the principles of the disclosure and to enable a person skilled in the relevant art to make and use the disclosure.

FIGS. 1A and 1B are diagrams illustrating a ring scanner in operation, according to aspects.

FIGS. 2A and 2B are schematic diagrams illustrating the ring scanner in greater detail, according to aspects.

FIG. 3 is a cross section of the ring scanner, according to aspects.

FIG. 4 is an architecture diagram illustrating hardware components of the ring scanner, according to aspects.

FIG. 5 is a flow diagram showing how the ring scanner routes a scanned image or barcode based on a keyword, according to aspects.

FIGS. 6A and 6B show what the operator of the ring scanner sees on a display of the ring scanner when selecting a keyword and scanning an image or barcode, according to aspects.

FIGS. 7A and 7B show graphics sent to the ring scanner by a destination computing device in response to the selected keyword and scanned image or barcode, according to aspects.

FIG. 8 shows a method of operating the ring scanner to use keywords to perform the routing function for a scanned image or barcode, according to aspects.

The drawing in which an element first appears is typically indicated by the leftmost digit or digits in the corresponding reference number. In the drawings, like reference numbers may indicate identical or functionally similar elements. The drawings are illustrative and may not be to scale.

### DETAILED DESCRIPTION

Prior art ring scanners are limited in their interactivity. For the most part, the ring scanners lack output display devices or input devices, and instead rely on external devices, perhaps strapped to the user's forearm. Aspects have integrated interactivity, including a touchscreen display and separate buttons that may be used to operate an optical scanner integrated with the ring scanner, and input data into an integrated computing device of the ring scanner.

A common problem with ring scanners is that operators of ring scanners often have to manually input a series of menu choices using multiple screens/icons to indicate what function the ring scanner should perform for a scanned image or barcode. The disclosed system and method solves this problem by introducing the use of predefined keywords that are mapped to a particular functionality of the ring scanner. These keywords allow an operator/user of a ring scanner to toggle between functions of the ring scanner by simply selecting a keyword. Thus, by selecting a single keyword and scanning an image or barcode, the ring scanner can automatically know what to do with a scanned image or barcode. This allows the operator of the ring scanner to quickly and efficiently scan images or barcodes. This feature is particularly useful where large numbers of images or barcodes are being scanned. For example, at a postal facility where thousands of packages are to be scanned and routed to their destinations each day, the disclosed keyword based approach to scanning packages can save an operator hours of scanning time because by simply toggling to a keyword linked with a function, for example, routing, the ring scanner can take the scan of the barcode and know where to route that barcode so that it may be routed to the proper destination for processing.

Ring Scanner Architecture

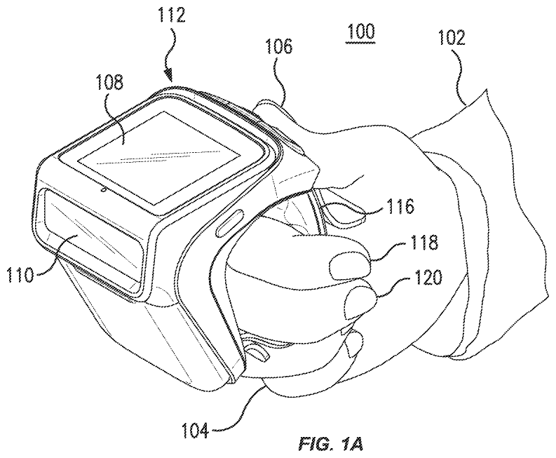

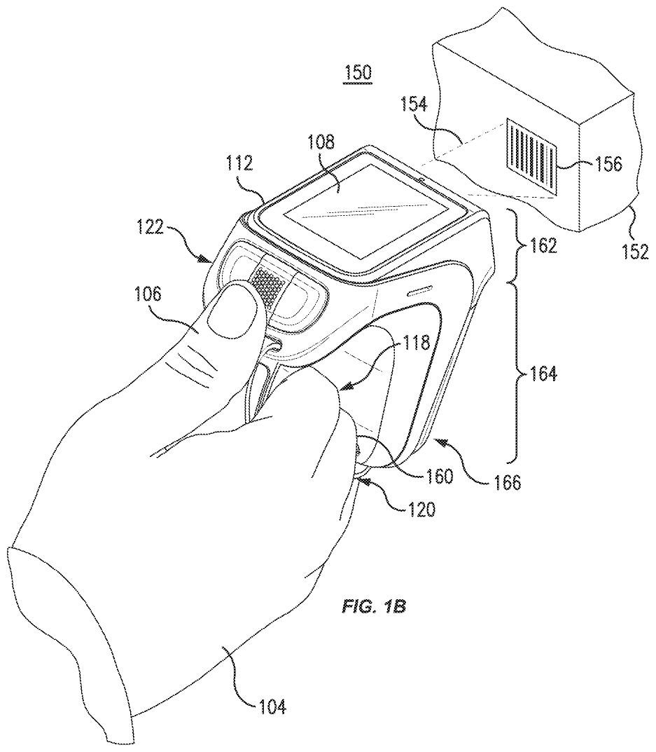

FIGS. 1A and 1B are diagrams illustrating a ring scanner in operation, according to aspects. FIG. 1A shows a diagram 100 with a user/operator having a hand 104 and forearm 102. Hand 104 is gripping a ring scanner 112. Ring scanner 112 has a display 108 and an optical scanner 110.

As may be seen in diagram 100, ring scanner 112 has a loop 116 through which an index finger 118 and a middle finger 120 pass through to grip and hold ring scanner 112. Loop 116 is configured to be gripped by index finger 118 and middle finger 120. It presses against the palmar side of index finger 118 and middle finger 120. Because loop 116 enables an operator to grip ring scanner 112 with just a loop around the operator's fingers, the operator maintains use of his or her hands. For example, the operator can continue to use his or her hands to operate equipment, carry packages, and climb ladders.

According to an aspect, loop 116 is configured to be gripped by index finger 118 and middle finger 120 such that the palm is in a neutral position when the optical detector is oriented in an upright direction. In this way, a user need not pronate the hand when transitioning from using the hand to grip a package from the package's side to scanning the optical label. The user's forearm 102 need not twist when scanning. Avoiding twisting in this way, the operator can avoid fatigue, discomfort, pain and even possible injury.

Display 108 is an output device for presentation of information in visual form. It outputs information that is supplied to it from a computing device (not shown) in ring scanner 112, converting electrical signals into light. In different aspects, display 108 may be an electroluminescent (ELD) display, liquid crystal display (LCD), light-emitting diode (LED) backlit LCD, thin-film transistor (TFT) LCD, light-emitting diode (LED) display, OLED display, AMOLED display, plasma (PDP) display, quantum dot (QLED) display, or electronic paper, such as E INK paper available from E Ink Corporation of Cambridge, Massachusetts.

Optical scanner 110 is an optical scanner that can read printed optical labels such as barcodes or can scan images of objects or take pictures of the objects, decode the data contained in the optical label, and send the data to a computer. It may include a light source, a lens, and a light sensor translating for optical impulses into electrical signals. In different aspects, optical scanner 110 may be a pen-type reader, a laser scanner, a charge-coupled device (CCD) reader, a light emitting diode (LED) scanner, a camera-based reader, a video camera reader, a large field-of-view reader, or an omnidirectional barcode scanner.

FIG. 1B shows a diagram 150 illustrating ring scanner 112 from a different perspective. As shown in diagram 100, ring scanner 112 is in this position to project light 154 to capture a barcode 156 on package 152.

As shown in diagram 150, barcode 156 is oriented in a horizontal direction, read left to right or right to left. Barcode 156 is a linear dimensional (1D), one dimensional barcode with its lines running vertical to ground. In other aspects, barcode 156 may be two-dimensional and use rectangles, dots, hexagons and other patterns. In other aspects, the package 152 itself may be scanned as an image/picture.

As shown in diagram 150, when positioned to capture barcode 156 in an upright direction the user's palm of hand 104 hand is oriented substantially vertically. The palm of hand 104 is orthogonal to the ground.

As shown in diagram 150, ring scanner 112 includes a body piece 166, which includes an upper body portion 162 and a lower body 164. Upper body portion 162 rests on a portion of index finger 118 facing a thumb 106 of hand 104. Lower body 164 covers a dorsal side of index finger 118 and middle finger 120 of hand 104. Upper body portion 162 and lower body 164 are affixed to one another and angled to cover at least a portion of the thumb-facing side of index finger 118 and the dorsal side of middle finger 120. Together with loop 116, upper body portion 162 and lower body portion 164 encircle index finger 118 and middle finger 120. More specifically, together with loop 116 (labeled in FIG. 1A), upper body portion 162 and lower body 164 may encircle a middle phalanx portion index finger 118 and middle finger 120.

Upper body portion 162 includes a plurality of buttons 122 that, when selected, causes ring scanner 112 to perform certain actions. Each of the plurality of buttons 122 may be a switch mechanism with a surface that may be depressed, or pushed, by a finger. When the surface is depressed an electrical signal is sent to input information and possibly trigger an action. Each of the plurality of buttons 122 may have a spring to return to their un-pushed state. Other types of buttons may be used as well, such as virtual buttons presented on a touchscreen display.

As will be described below, the plurality of buttons 122 may cause optical scanner 110 to activate and scan barcode 156 or may input data into a computing device controlling aspects of ring scanner 112. The plurality of buttons 122 are positioned on ring scanner 112 to be selected by thumb 106.

In particular, buttons 122 are positioned to be selected by thumb 106 when hand 104 is gripping a ring scanner 112, and index finger 118 and middle finger 120 are bent. According to an aspect, buttons 122 are positioned to be selected when index finger 118 and middle finger 120 are bent at a proximal interphalangeal joint 160. Proximal interphalangeal joint 160 sits between a middle phalanx and proximal phalanx of index finger 118 and middle finger 120. Bending at proximal interphalangeal joint 160 may be more ergonomical than bending other joints, such as the metacarpophalangeal joint of index finger 118 and middle finger 120.

Display 108 may be a touchscreen display. A touchscreen display is an assembly of both an input (touch panel) and output (display) device. The touch panel may be layered on the top of the output electronic visual display. A user can give input or control a computing device (not shown) in ring scanner 112 through simple or multi-touch gestures by touching the screen with a special stylus or one or more fingers. In different examples, a touch panel may be a resistive touchscreen panel, a surface acoustic wave (SAW) touch panel, a capacitive touchscreen panel, or an infrared touchscreen panel.

When display 108 is a touchscreen display, display 108 will also be positioned such that at least a portion of display 108 may be selected by thumb 106 when hand 104 is gripping a ring scanner 112, and index finger 118 and middle finger 120 are bent at the proximal interphalangeal joint 160. Display 108 is configured to output visually from the computing device.

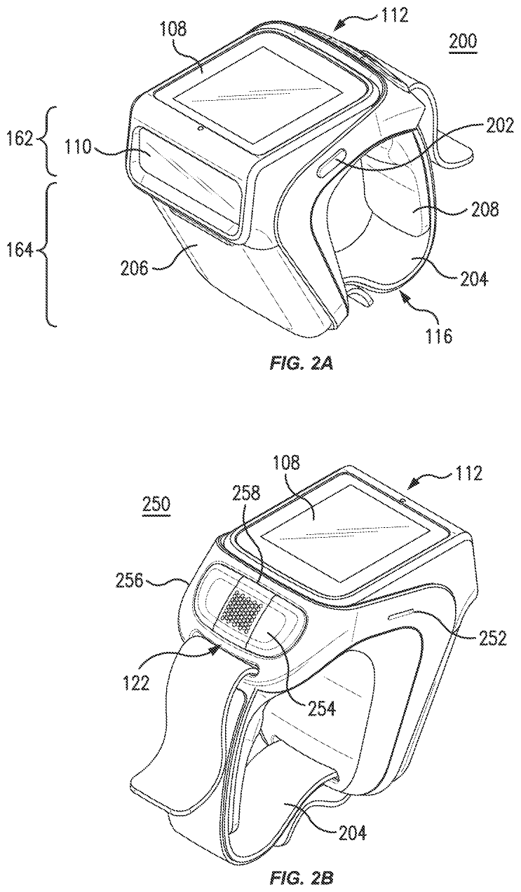

FIGS. 2A and 2B are schematic diagrams illustrating the ring scanner 112 in greater detail, according to aspects. FIG. 2A illustrates a front three-quarter view 200 of ring scanner 112. As shown from this perspective, ring scanner 112 includes a battery 206, power button 202, strap 204, and semi-rigid portion 208.

Battery 206 is a device including one or more electrochemical cells to provide power for ring scanner 112. In an example, battery 206 may be a lithium-ion battery. According to an aspect, battery 206 may be removable so that it may be swapped out with fully charged batteries when battery 206 is depleted. Additionally or alternatively, battery 206 could be internal to device 212 and not removable. Battery 206 may be rechargeable.

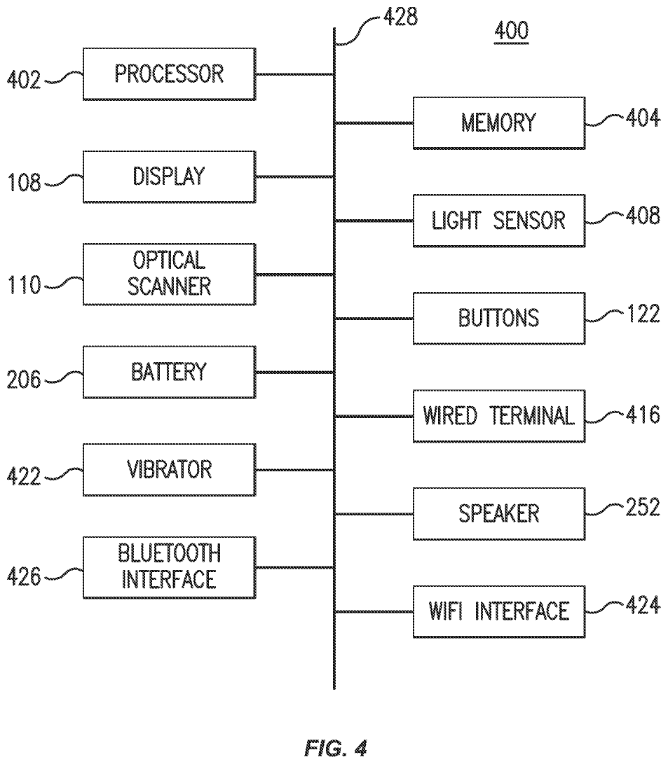

Power button 202 is a button that, when selected, causes ring scanner 112 to power on or off. When ring scanner 112 powers on, electricity is delivered from battery 206 to components of ring scanner 112, such as optical scanner 110, display 108, and other hardware components as will be discussed in greater detail with respect to FIG. 4.

Strap 204 is a ribbon used to fasten ring scanner 112 to the operator's fingers. As described above, strap 204, in conjunction with other components of ring scanner 112 may encircle an operator's fingers. Strap 204 may be made of nylon webbing, leather or other flexible materials. It also may be an adjustable strap positioned to encircle the at least one finger.

Semi-rigid portion 208 protrudes from upper portion 162 and is situated behind strap 204, in particular between strap 204 and the operator's fingers (not shown). Semi-rigid portion 208 may be flexible such that, as strap 204 is tightened, the tightened strap may pull semi-rigid portion 208 to tighten on the operator's fingers. Semi-rigid portion 208 may serve to allow strap 204 to be tightened, enabling the operator to maintain a tight grip on ring scanner 112 without irritating the operator's fingers. In an aspect, semi-rigid portion 208 may be made of rubber or a rubber-like material. In illustrative examples, semi-rigid portion 208 may be made of Thermoplastic Polyurethane (TPU), Thermoplastic Elastomer (TPE), butyl (IIR), nitrile (NBR), Neoprene® (CR), Ethylene Propylene Diene Monomer (EPDM), Silicone (Q), or Viton®.

FIG. 2B illustrates a rear three-quarter view 250 of ring scanner 112. As may be seen from this perspective, ring scanner 112 includes a speaker 252 and plurality of buttons 122.

Speaker 252 is a device which converts an electrical audio signal into a corresponding audible sound. Example speakers include moving-iron loudspeakers, piezoelectric speakers, magnetostatic loudspeakers, electrostatic loudspeakers, ribbon and planar magnetic loudspeakers, bending wave loudspeakers, flat panel loudspeakers, Heil air motion transducers, transparent ionic conduction speakers, plasma arc speakers, thermoacoustic speakers, rotary woofers, moving-coil, electrostatic, electret, planar magnetic, and balanced armature.

As illustrated in FIG. 2B, buttons 122 includes three buttons: left button 256, right button 254, and center button 258. Left and right buttons may input selections into a computing device (not shown) in ring scanner 112. This may cause an action to be specified by an application executed by the computing device. In one example, the application may display a menu on display 108 and selecting buttons 254 and 256 may enable a user to navigate through lists or menus. In this way, aspects enable interactive applications to be executed by ring scanner 112.

Center button 258 is configured to, when selected, activate optical scanner 110 to read a barcode or scan an image. It also may send input data to the computing device of the ring scanner 112.

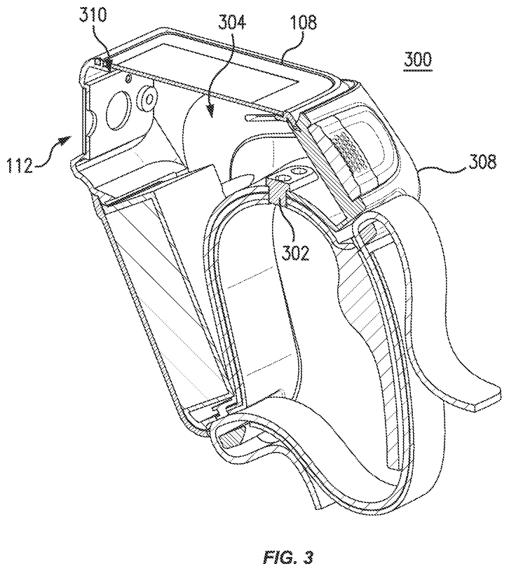

FIG. 3 is a cross section of the ring scanner 112, according to aspects. Housing 308 is a protective exterior (e.g. shell) or an enclosing structural element (e.g. chassis or exoskeleton) designed to enable easier handling, provide attachment points for internal mechanisms (e.g. mounting brackets for electrical components, cables and pipings), maintain cleanliness of the contents by shielding dirt/dust, fouling and other contaminations, or protect interior mechanisms (e.g. delicate integrated electrical fittings) from structural stress and/or potential physical damage.

The interior of housing 308 includes a cavity 304 that contains various electronic components, as illustrated in FIG. 4. Housing 308 includes an opening 310 display 108 and other openings, such as an opening for a charging port 302 when charging the battery 206.

Charging port 302 is configured to electrically couple ring scanner 112 to a cradle and positioned directed toward the loop. Charging port 302 may be a USB port as discussed with respect to FIG. 4 below. Ring scanner 112 may include at least one magnet (not shown) positioned to align the charging port to the cradle to enable electrical coupling.

Alternatively or additionally, ring scanner 112 may be capable of wireless charging. For example, ring scanner 112 may have a silicon chip that receives a beacon signal to charge the device. For example, the chip may enable a power transmitter to locate a device and transmit power directly to the device, along the path used to detect the chip. This path based functionality may allow the wireless power transmitter to continuously and safely sent power when needed. In examples, ring scanner 112 may use the COTA power transmitter/receiver available from Ossia Inc. of Bellevue, WA or the WattUp power transmitter/receiver available from Energous Corporation.

FIG. 4 is an architecture diagram 400 illustrating hardware components of the ring scanner 112, according to aspects. As discussed with respect to previous figures, diagram 400 includes display 108, optical scanner 110, buttons 122, battery 206, and speaker 252. In addition to those components, diagram 400 includes a processor 402, memory 404, light sensor 408, wired terminal 416, vibrator 422, Bluetooth interface 426 and Wi-Fi interface 424. Each of these components of FIG. 4 is enclosed within housing 308 shown in FIG. 3.

Bus 428 is a communication system that transfers data between the hardware components of a ring scanner. In addition to transferring data, bus 428 may also transfer electrical power, such as from battery 206 to other components. In this way, bus 428 communicatively and electrically couples the various components.

It may be appreciated for those skilled in the art that a plurality of signal lines or buses may exist, thus different components may be linked by different signal lines or buses, and that a signal line or bus depicted in the schematic diagram may represent a plurality of such.

Memory 404 may include random access memory (RAM) and may also include nonvolatile memory, such as read only memory (ROM) and/or flash memory. Memory 404 may be embodied as an independent memory component, and may also be embedded in another component, such as processor 402, or may be embodied as a combination of independent as well as embedded, and/or a plurality of memory components is present, the invention is not so limited. Memory 404 is adapted to include software modules (a module is a set of instructions).

Processor 402 is adapted to run instructions stored in memory 404. Processor 402 may be a micro-controller unit (MCU), a digital signal processor (DSP) and/or an Image/Video Processing unit or the like components that run instructions. An example of an MCU is MSP432P401x, available from Texas Instruments Inc. of Dallas, Texas. An example of a DSP is C5000, available from Texas Instruments Inc. An example of an image/video processor is OMAP3525, available from Texas Instruments Inc. One or more processors may be present. Processor 402 may be an independent component, it may also be embedded in another component, such as in light sensor/camera 408, or any combination thereof.

Wired terminal 416 is adapted to attach to a wired network, including, but not limited to, Ethernet, USB or thunderbolt.

Diagram 400 includes two wireless interfaces, Wi-Fi interface 424 and Bluetooth interface 426. Wi-Fi interface 424 may provide a network interface accessible by applications running on processor 402. Bluetooth interface 426 may be adapted to enable the ring scanner 112 to interact with peripheral devices, such as headsets (not shown).

Light sensor 408 is a photodetector. It is a sensor of light. A photo detector has a p— n junction that converts light photons into current. The absorbed photons make electron— hole pairs in the depletion region. Photodiodes and photo transistors are a few examples of photo detectors. In a different example, light sensor 408 may be a photoemission or photoelectric effect photodetector, thermal photodetectors, polarization photodetectors, or photochemical photodetectors. Light sensor 408 may be integrated into a camera of the ring scanner 112.

In an example operation, light sensor 408 may signal to processor 402 when light is detected. Processor 402, in turn, may adjust the brightness of display 108. Automatically adjusting brightness in this way may have the effect of conserving power in battery 206.

Vibrator 422 is a device that causes vibration when receiving a specified signal from processor 402. Vibrator 422 is a mechanical device to generate vibrations. To generate the vibrations, vibrator 422 may include an electric motor with an unbalanced mass on its driveshaft. Vibrator 422 may be a vibrating structure gyroscope implemented as a microelectromechanical system (MEMS).

Speaker 252 is coupled to processor 402 and is configured to cause the ring scanner 112 to emit sound as specified by commands from processor 402. In this way, speaker 252 may provide audio to a user of the ring scanner 112 as specified by an application executed on processor 402.

But the buttons 122 may send commands to the processor 402, or other components such as optical scanner 110. When a user presses one of buttons 122, a signal may be sent to processor 402. That signal may cause an interrupt command in the software application executed by processor 402, causing processor 402 to run specific commands that an application specifies to correspond to that button input. In this way, using buttons 122, a user can trigger actions as specified by the application executed by processor 402.

In response to inputs it receives from buttons 122, processor 402 can output information to display 108 as specified by a software application executed by processor 402. In addition, as mentioned above, display 108 may be a touchscreen display. In this way, interactive applications may be implemented within the ring scanner 112.

In addition, not shown, other input devices may be included, such as a radiofrequency identification (RFID) reader and a near field communication (NFC) reader. RFID uses electromagnetic fields to automatically identify and track tags attached to objects. An RFID system consists of a tiny radio transponder, a radio receiver and transmitter. When triggered by an electromagnetic interrogation pulse from RFID reader, an RFID tag transmits digital data back to the reader. A NFC reader may allow for collection of payment data from an EMV chip or from a user's mobile device (not shown).

In examples, these NFC and RFID readers may be used for login purposes. An operator can swipe her badge in vicinity of a ring scanner 112 having these features and the ring scanner 112 can log her in using the information received from the NFC chip or the badge. Then, when the operator is using the ring scanner 112, any scanned items are tracked with an identification of the operator who logged into the ring scanner 112.

### Using Keywords to Toggle Between Functions of the Ring Scanner

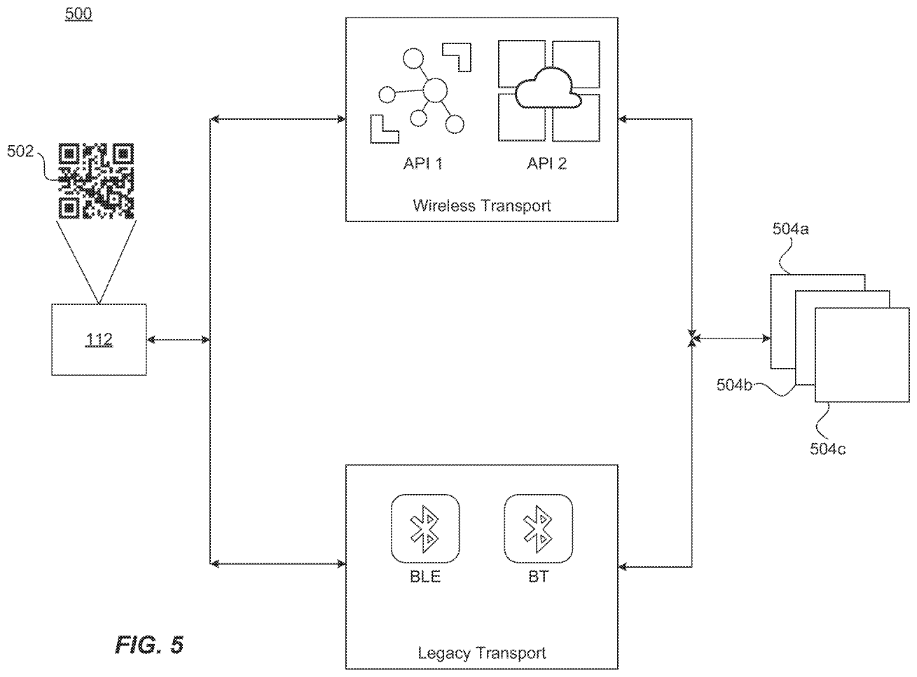

FIG. 5 is a flow diagram 500 showing how the ring scanner 112 routes a scanned image or barcode based on a keyword, according to aspects. Flow diagram 500 will be described using an example use case where the keyword is linked to a routing function. This, however, does not need to be the case. Keywords may be linked to other functions of a ring scanner 112.

Flow diagram 500 may begin by having an operator/user of the ring scanner 112 select a keyword from a plurality of keywords displayed on the display 108 of the ring scanner 112. In aspects, the plurality of keywords may be different words (such as verbs) that may be preprogrammed to cause the ring scanner 112 to perform a particular function when chosen, and to be associated with a scanned image or barcode. In the example with respect to FIG. 5, the function performed is a routing function, where the scanned image or barcode will be routed to a destination computing device 504. Thus, based on what keyword is chosen by the operator/user, the scanned image or barcode may be routed to a different destination computing device 504 that can recognize the scanned image or barcode, and process that scanned image or barcode to extract information from it or provide other functions based on it. In this way, images or barcodes for different applications and/or associated with different people or objects (e.g., drivers licenses, packages, employees, patient information, etc.) may be sent to the proper destination computing device 504 that will know how to handle, extract information, and process these scanned images or barcodes. In aspects, the destination computing device 504 can also generate an output based on processing the scanned image or barcode. The output may be transmitted back to the ring scanner 112 to be displayed on the display 108. How the output is generated and what outputs may be generated will be discussed further below.

The destination computing device 504 may be any of a mobile device, a laptop computer, a desktop computer, grid-computing resources, a virtualized computing resource, cloud computing resources, peer-to-peer distributed computing devices, a server farm, or a combination thereof, such that it is able to execute the rules and/or logic to facilitate the processing of the scanned image or barcode. In FIG. 5, multiple destination computing devices 504a, 504b, 504c are shown. In aspects, each of these destination computing devices can perform a particular function for a scanned image or barcode. For example, one can process barcodes related to driver's licenses, one can process barcodes related to mailed packages, one can process barcodes related to employee badges, etc.

In aspects, the ring scanner 112 can receive an input selection of the keyword from amongst the plurality of keywords. The input selection may be obtained by having the operator toggle between the plurality of keywords using buttons (e.g., buttons 122 described with respect to FIGS. 1B and 2B) of the ring scanner to move forward or backward between the plurality of keywords to choose a keyword.

In aspects, once the keyword is chosen, the operator can press a button 122 to also scan an image or barcode using the optical scanner 110 (similar to what was as described with respect to FIG. 1B). In this way, the keyword and scanned image or barcode may be linked together.

FIG. 5 shows barcode 502 being scanned. Barcode 502 is shown as a QR code. In aspects, barcode 502 may be associated/linked to with a person or object. With respect to FIG. 5, barcode 502 will be described as being linked to and/or printed as a label on, for example, a postal package (e.g., package 152 described with respect to FIG. 1B). This is for ease of description. In other aspects, the barcode 502 may be associated with/linked to people or objects by being a barcode 502 of a driver's license, an employee badge, product packaging, or other objects that are to be tracked. Other example applications may be barcodes on tags of rental cars, airline luggage, nuclear waste, etc. While a barcode 502 is described, similar processes can also be performed for captured images that are scanned by the optical scanner 110. These scanned images can include pictures taken of objects by cameras embedded in the optical scanner 110.

In aspects, barcode 502 can contain information such that when it is scanned, it can indicate information about the package, object, or person that it is associated with/linked with. In the case where barcode 502 is linked to a postal package, the information can indicate information the source of the package, its destination, its contents, any freight status (e.g., first class, priority, standard, fragile, etc.), or any other information that is typically associated with the transport of a package via mail or courier. Barcode 502 can also contain a deep link that when processed by the ring scanner 112 can indicate the destination computing device 504 to route the scanned barcode 502 to. In aspects, the deep link may be in the form of a Uniform Resource Locator (URL), an IP address, or any other address identifying the destination computing device 504 that may be encoded into the barcode 502.

In aspects, and as indicated once routed to the destination computing device 504, the destination computing device 504 can execute rules and/or logic to perform some function based on the scanned image or barcode. In aspects, the rules and/or logic may be in the form of a computer software program. For example, the rules and/or logic may be part of a business rule management system (BRMS) implemented as software, may be part of if-else logic, or may be part of a software program designed to process scanned images or the barcode 502 to facilitate whatever function is linked to the keyword. In the example where the barcode 502 is linked to a postal package, the rules and/or logic can, for example, update databases or personnel about the status, location, or shipping/receipt of the package. The rules and/or logic can also result in the generation of messages or notifications to computers and/or personnel indicating the status, location, or shipping/receipt of the package. For example, the status can indicate the condition of the package (e.g., is the package damaged or not). The location can indicate where the package is currently located, updates about the location of the package, what warehouse or facility the package is located at, etc. The shipping/receipt information can indicate whether the package is in transit, where it is being shipped from, where it is being received, the customs status of the package, etc.

In aspects, and as indicated, once the ring scanner 112 receives the input selection of the keyword and the scanned barcode 502, it can route the scanned barcode 502 to the destination computing device 504 based on the keyword. In aspects, this routing may be facilitated by having the ring scanner 112 access a stored lookup table that is preprogrammed to map the keyword to a destination computing device 504 via a routing function. The routing function may be a rule, script, and/or software code that can indicate a method and manner to route the scanned image or barcode 504, to what destination computing device 504 to route the scanned image or barcode 502 to, what communications protocol or platform to use to route the scanned image or barcode 502, etc. In aspects, each of the plurality of keywords can have a unique routing function associated with it. Thus, each of the keywords can perform a different routing. For example, if the keyword is “REPORT,” the routing function can transmit the scanned image or barcode 502 to a destination computing device 504 dedicated to tracking damaged packages. If the keyword is “SHIP,” the routing function can transmit the scanned image or barcode 502 to a destination computing device 504 dedicated to tracking shipping information of a package. These are merely examples, and other keywords may be linked to different destination computing devices.

In aspects, the lookup table may be implemented as a database, series of databases, or a data structure that can store the mapping of the plurality of keywords to the destination computing device 504 and indicate the routing function to be performed. In aspects, the lookup table may be stored in memory 404 of the ring scanner 112 and may be accessed by processor 402 when it is executing instructions to perform the routing function.

In aspects, the routing function can also indicate a communications method/platform to be used when performing the routing. As indicated with respect to FIG. 4, the ring scanner 112 is capable of transmitting via a wired terminal 416, Bluetooth interface 426, or Wi-Fi interface 424. In aspects, and based on the available connectivity and/or the connection available to the destination computing device 504 the ring scanner 112 can transmit the scanned image or barcode 502 via any of these interfaces to the destination computing device 504. In aspects, the ring scanner 112 can further be configured to interface with application programming interfaces (APIs) to transmit the scanned image or barcode 502. Such APIs may be, for example, Representation State Transfer (REST) based APIs installed on the ring scanner 112. The APIs can provide an interface between the ring scanner 112 and destination computing devices to facilitate transmitting the scanned images or barcode 502 to the destination computing device 504 by passing the scanned images or barcode 502 between the devices and over communication platforms, along with any other information, as data objects, parameters, or variables.

In aspects, once the scanned image or barcode 502 is transmitted to the destination computing device 504, as indicated, the destination computing device 504 can have rules and/or logic to facilitate the processing of the scanned image or barcode. In aspects, as a result of executing the rules and/or logic on the scanned image or barcode 502, the destination computing device 504 can generate an output. In aspects, the output may be in the form of a graphic, message, or a combination thereof. For example, the output may be a graphic to be displayed on the display 108 of the ring scanner 112. The graphic may be represented in a graphical user interface (GUI) or may be the GUI itself. In aspects, the graphic may be generated using any markup language such as Hypertext Markup Language (HTML) or a proprietary computer language meant to generate such graphics.

In aspects, the graphic may be interactive or static (i.e., not interactive). For example, in the case of scanning barcodes of drivers licenses and selecting a keyword linked to the function of verifying the ages of individuals to which the licenses belong, the graphic that may be generated may be a static GUI showing whether the individuals to which the licenses belong are over a certain age (e.g., 18 or 21). Further, the graphic can include a color scheme. For example, if the individuals are over the certain age, the graphic can show up as green, while if they are under the certain age limit the graphic can show up as red. Similarly, fonts may be generated to emphasize certain messages or highlight certain information within the graphic. In another example, if the barcode that is scanned relates to a package being transported, and a keyword that is selected is related to the function of reporting whether the package is damaged or not, the graphic that may be generated may be an interactive graphic. For example, the graphic may be a GUI with further icons/interactive buttons that may be selected by the operator of the ring scanner 112 via the display 108 to indicate whether the package is damaged or not damaged.

In aspects, once generated, the graphic may be transmitted from the destination computing device 502 to the ring scanner 112, which can receive the graphic. In aspects, this transmission may be in real-time. Real-time refers to within seconds or milliseconds of when the image or barcode is scanned and routed to the destination computing device 502. In aspects, the graphic may be stored in memory 404 and may be accessed by the processor 402, which may be configured to transmit the graphic to display 108 so that it may be displayed on the display 108 of the ring scanner 112.

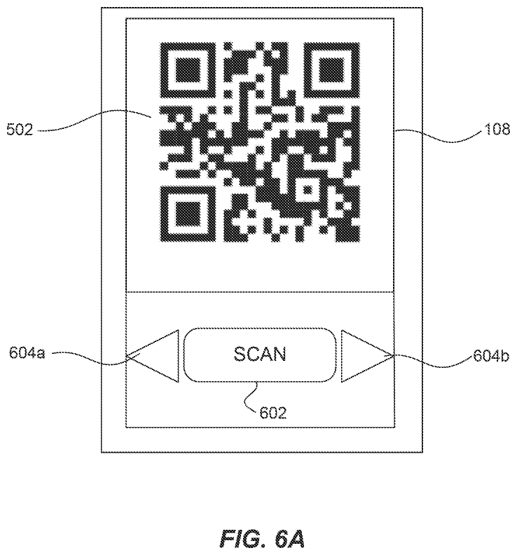

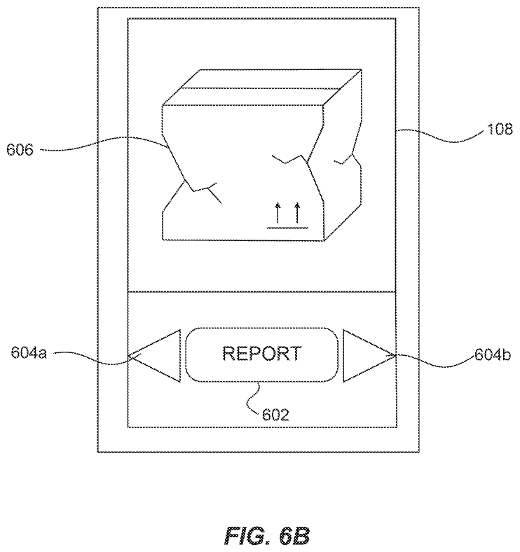

FIGS. 6A and 6B show what the operator of the ring scanner 112 sees on the display 108 of the ring scanner 112 when selecting a keyword and scanning an image or barcode, according to aspects. FIG. 6A shows barcode 502 described with respect to FIG. 5 displayed on the display 108. FIG. 6A also shows an icon 602 with a keyword shown on it. In the example shown in FIG. 6A, the keyword is “SCAN,” indicating that barcode 502 is to be scanned. In aspects, the keyword may be further linked to other functions such as storing the information related to the scanned barcode 502 into a database. The aforementioned is merely exemplary and other functions may be linked to the keyword.

In aspects, two icons 604a and 604b can also be shown on display 108. Icons 604a and 604b indicate a forward and reverse direction to toggle/scroll through the plurality of keywords. In aspects, icons 604a and 604b can correspond to left button 256 and right button 254 described with respect to FIG. 2B, such that when left button 256 and right button 254 are pressed the operator can scroll through the plurality of keywords until the desired keyword is found. In aspects, to scan the image or barcode 502 when the keyword is chosen, the operator can press center button 258 described with respect to FIG. 2B. FIG. 6B shows the similar functionality and display setup as FIG. 6A, except for the ring scanner 112 performing a scan of an image. In the example shown in FIG. 6B, a package 606 is scanned to report damage. As a result, the icon 602 displays the keyword “REPORT.”

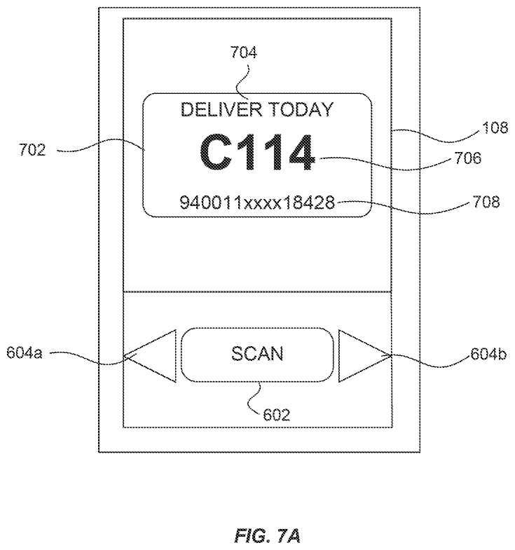

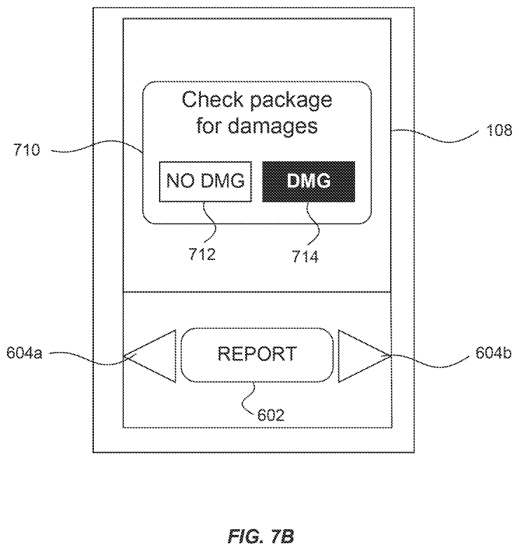

FIGS. 7A and 7B show graphics sent to the ring scanner 112 by a destination computing device 504 in response to the selected keyword and scanned image or barcode, according to aspects. FIG. 7A shows graphic 702. Graphic 702 is an example GUI that indicates information resulting from a scanned barcode of a package to transported. In aspects, graphic 702 can display a delivery status 704, a package identifying number 706, and a tracking identification number 708 for the delivery. FIG. 7B shows a graphic 710. Graphic 710 is an example GUI that is interactive and may be generated in response to scanning a package to report whether it is damaged or not damaged. In aspects, graphic 710 can have icons 712 and 714. Icons 712 and 714 may be selected by the operator to indicate whether the package is damaged or not damaged as described with respect to FIG. 5.

The functions described in FIGS. 1-7B may be implemented as instructions stored on a non-transitory computer readable medium to be executed by one or more computing devices such as the processor 402, a special purpose computer, an integrated circuit, integrated circuit cores, or a combination thereof of the ring scanner 112 or the destination computing device 504. The non-transitory computer readable medium may be implemented with any number of memory units, such as a volatile memory, a nonvolatile memory, an internal memory, an external memory, or a combination thereof. The non-transitory computer readable medium may be integrated as a part of the ring scanning device 112 or destination computing device 504, or installed as a removable portion of the ring scanning device 112 or destination computing device 504.

The processes with respect to the ring scanner 112 described above improves the state of the art from previous ring scanners because it introduces a novel way to have the ring scanner 112 process scanned images and barcodes. First, the ring scanner 112, by using the plurality of keywords that are linked to functions, can provide a quick and efficient mechanism and interface by which operators of the ring scanner 112 can perform tasks using the ring scanner 112. For example, a keyword may be chosen that is tied to a specific task, such as scanning, verifying information, performing an optical character recognition (OCR), etc. By simply selecting the keyword and scanning an image or barcode, the ring scanner 112 can take care of the routing to the scanned image or barcode to the correct destination computing device 504 to process the scanned image or barcode. This is different from conventional systems, which require an operator to manually select from menus or icon lists what function is to be performed for each scanned image or barcode. The disclosed ring scanner 112 thus saves the operator time when scanning images or barcodes.

Tied to the use of the plurality of keywords to perform a function, is the ability of the operator to perform these functions using one finger to toggle through the plurality of keywords. The design of the ring scanner 112, which has buttons 122 that may be pressed to move forward and backward to scroll through the plurality of keywords using the same finger/thumb on the hand that the ring scanner 112 is attached to allows the operator to have one free hand to perform other tasks while performing scans with the hand on which the ring scanner 112 is attached. This is referred to as a touchless design. This is different from conventional ring scanners 112, which require the operator to use both hands to select menu items to select what functions to perform using the ring scanner 112.

The use of the plurality of keywords also allows the ring scanner 112 to have less software code installed thereon. Conventional ring scanners typically have all the functionality that the ring scanners are to perform implemented as software on the ring scanners themselves. The use of the plurality of keywords tied to functions, for example, routing functions that allow a scanned image or barcode to be transmitted to destination computing devices to be processes allows for the ring scanner 112 to offload processing of the scanned images or barcodes to these destination computing devices. In this way, the ring scanner 112 may become a lightweight off the shelf device that requires minimal configuration out of the box to be used. It will also require less memory to function improving the memory requirements and costs associated with the ring scanner 112 itself.

### Methods of Operation

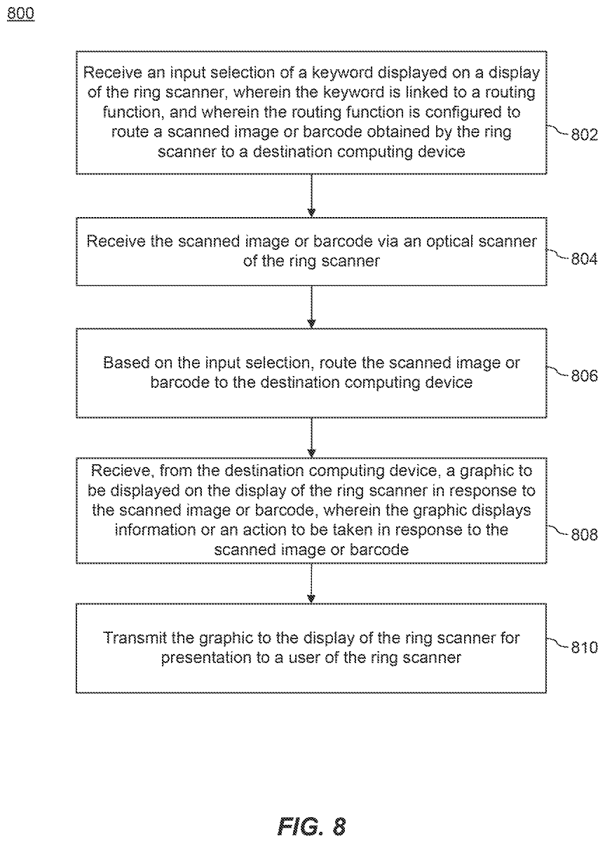

FIG. 8 shows a method 800 of operating the ring scanner 112 to use keywords to perform the routing function for a scanned image or barcode, according to aspects. As shown in step 802, method 800 includes receiving an input selection of a keyword displayed on a display 108 of the ring scanner 112. The keyword may be linked to a routing function, and the routing function may be configured to route a scanned image or barcode obtained by the ring scanner 112 to a destination computing device 504. At step 804, the ring scanner 112 can receive the scanned image or barcode via an optical scanner 110 of the ring scanner 112. At step 806, based on the input selection, the ring scanner 112 can route the scanned image or barcode to the destination computing device 504. The destination computing device 504 can then process the scanned image or barcode. At step 808 the ring scanner 112 can receive from the destination computing device 504, a graphic to be displayed on the display of the ring scanner 112 in response to processing the scanned image or barcode. The graphic can display information or an action to be taken in response to the scanned image or barcode. At step 810 the graphic may be transmitted to the display 108 for presentation to an operator/user of the ring scanner 112. The operations of method 800 are performed by ring scanner 112 in accordance with aspects described above.

The above detailed description and aspects of the disclosed ring scanner 112 and destination computing device 504 are not intended to be exhaustive or to limit the disclosed ring scanner 112 and destination computing device 504 to the precise form disclosed above. While specific examples for the ring scanner 112 and destination computing device 504 are described above for illustrative purposes, various equivalent modifications are possible within the scope of the disclosed ring scanner 112 and destination computing device 504, as those skilled in the relevant art will recognize. For example, while processes and methods are presented in a given order, alternative implementations may perform routines having steps, or employ systems having processes or methods, in a different order, and some processes or methods may be deleted, moved, added, subdivided, combined, or modified to provide alternative or sub-combinations. Each of these processes or methods may be implemented in a variety of different ways. Also, while processes or methods are at times shown as being performed in series, these processes or blocks may instead be performed or implemented in parallel, or may be performed at different times.

The resulting method, process, apparatus, device, product, and ring scanner 112 and destination computing device 504 is cost-effective, highly versatile, and accurate, and may be implemented by adapting components for ready, efficient, and economical manufacturing, application, and utilization. Another important aspect of an aspect of the present disclosure is that it valuably supports and services the historical trend of reducing costs, simplifying systems, and increasing performance.

These and other valuable aspects of the aspects of the present disclosure consequently further the state of the technology to at least the next level. While the disclosed aspects have been described as the best mode of implementing the ring scanner 112 and destination computing device 504, it is to be understood that many alternatives, modifications, and variations will be apparent to those skilled in the art in light of the descriptions herein. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A computer implemented method comprising:
receiving, by one or more computing devices of a ring scanner, an input selection of a keyword displayed on a display of the ring scanner, wherein the keyword is linked to a routing function, and wherein the routing function is configured to route a scanned image or barcode obtained by the ring scanner to a destination computing device;
receiving the scanned image or barcode via an optical scanner of the ring scanner;
based on the input selection, routing the scanned image or barcode to the destination computing device;
receiving, from the destination computing device, a graphic to be displayed on the display of the ring scanner in response to the scanned image or barcode, wherein the graphic displays information or an action to be taken in response to the scanned image or barcode; and
transmitting the graphic to the display of the ring scanner for presentation to a user of the ring scanner.

2. The method of claim 1, wherein the keyword is one of a plurality of keywords stored on the ring scanner, and wherein each of the keywords is linked to a unique routing function.

3. The method of claim 2, further comprising selecting the keyword from the plurality of keywords by scrolling through the plurality of keywords using a button of the ring scanner to scroll through the plurality of keywords.

4. The method of claim 1, wherein the routing is performed via: a WiFi connection or a Bluetooth connection.

5. The method of claim 1, wherein the graphic includes an interactive button to be displayed on the display of the ring scanner that the user can interact with to perform the action.

6. The method of claim 1, further comprising receiving the graphic from the destination computing device in real time from when the scan of the scanned image or barcode is routed to the destination computing device.

7. The method of claim 1, further comprising:
accessing a lookup table that maps the keyword to the routing function;
determining the routing function to be performed based on the lookup table; and
performing the routing of the scanned image or barcode to the destination computing device based on the determined routing function.

8. A non-transitory computer readable medium having instructions stored thereon that when executed by a computing system, cause the computing system to perform operations comprising:
receiving, by one or more computing devices of a ring scanner, an input selection of a keyword displayed on a display of the ring scanner, wherein the keyword is linked to a routing function, and wherein the routing function is configured to route a scanned image or barcode obtained by the ring scanner to a destination computing device;
receiving the scanned image or barcode via an optical scanner of the ring scanner;
based on the input selection, routing the scanned image or barcode to the destination computing device;
receiving, from the destination computing device, a graphic to be displayed on the display of the ring scanner in response to the scanned image or barcode, wherein the graphic displays information or an action to be taken in response to the scanned image or barcode; and
transmitting the graphic to the display of the ring scanner for presentation to a user of the ring scanner.

9. The non-transitory computer readable medium of claim 8, wherein the keyword is one of a plurality of keywords stored on the ring scanner, and wherein each of the keywords is linked to a unique routing function.

10. The non-transitory computer readable medium of claim 9, wherein the operations further comprise selecting the keyword from the plurality of keywords by scrolling through the plurality of keywords using a button of the ring scanner to scroll through the plurality of keywords.

11. The non-transitory computer readable medium of claim 8, wherein the routing is performed via: a WiFi connection or a Bluetooth connection.

12. The non-transitory computer readable medium of claim 8, wherein the graphic includes an interactive button to be displayed on the display of the ring scanner that the user can interact with to perform the action.

13. The non-transitory computer readable medium of claim 8, wherein the operations further comprise receiving the graphic from the destination computing device in real time from when scanned image or barcode is routed to the destination computing device.

14. The non-transitory computer readable medium of claim 8, wherein the operations further comprise:
accessing a lookup table that maps the keyword to the routing function;
determining the routing function to be performed based on the lookup table; and
performing the routing of the scanned image or barcode to the destination computing device based on the determined routing function.

15. A ring scanner comprising:
a memory configured to store instructions; and
one or more processors, coupled to the memory and configured to process the stored instructions to:
receive an input selection of a keyword displayed on a display of the ring scanner, wherein the keyword is linked to a routing function, and wherein the routing function is configured to route a scanned image or barcode obtained by the ring scanner to a destination computing device;
receive the scanned image or barcode via an optical scanner of the ring scanner;
based on the input selection, route the scanned image or barcode to the destination computing device; and
receive, from the destination computing device, a graphic to be displayed on the display of the ring scanner in response to the scanned image or barcode, wherein the graphic displays information or an action to be taken in response to the scanned image or barcode; and
transmit the graphic to the display of the ring scanner for presentation to a user of the ring scanner.

16. The ring scanner of claim 15, wherein the keyword is one of a plurality of keywords stored on the ring scanner, and wherein each of the keywords is linked to a unique routing function.

17. The ring scanner of claim 16, wherein the one or more processors are further configured to select the keyword from the plurality of keywords by scrolling through the plurality of keywords using a button of the ring scanner to scroll through the plurality of keywords.

18. The ring scanner of claim 15, wherein the routing is performed via: a WiFi connection or a Bluetooth connection.

19. The ring scanner of claim 15, wherein the graphic includes an interactive button to be displayed on the display of the ring scanner that the user can interact with to perform the action.

20. The ring scanner of claim 15, wherein the one or more processors are further configured to:
access a lookup table that maps the keyword to the routing function;
determine the routing function to be performed based on the lookup table; and
perform the routing of the scanned image or barcode to the destination computing device based on the determined routing function; and
receive the graphic from the destination computing device in real time from when scanned image or barcode is routed to the destination computing device.
